(19) United States
(12) Patent Application Publication
(10) Pub. No.: US 2006/0006645 A1
(43) Pub. Date: Jan. 12, 2006

(54) Pressure resistant vibration absorbing hose

(76) Inventors: Hajime Mukawa, Nagoya-city (JP); Keiichi Kitamura, Handa-city (JP); Tetsuya Arima, Kasugai-shi (JP); Norihiko Furuta, Komaki-shi (JP); Ayumu Ikemoto, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/176,729

(22) Filed: Jul. 6, 2005

(30) Foreign Application Priority Data
Jul. 8, 2004 (JP) 2004-202407

(51) Int. Cl. F16L 33/00

(52) U.S. Cl. 285/256

(57) ABSTRACT

A pressure resistant vibration absorbing hose has a hose body including an inner surface rubber layer, a reinforcing layer and an outer surface rubber layer and a joint fitting including a rigid insert pipe and a socket fitting. The joint fitting is attached to a swaged portion of an axial end portion of the hose body by securely swaging the socket fitting thereto. The inner surface rubber layer is formed by molding such that a swaged portion thereof is larger than a main portion thereof in diameter and a wall thickness of the swaged portion is equal to or larger than a wall thickness of the main portion, and after that, the reinforcing layer and the outer surface rubber layer are laminated to construct the hose body.

### BACKGROUND OF THE INVENTION

The present invention relates to a pressure resistant vibration absorbing hose, specifically a pressure resistant vibration absorbing hose to be applied preferably for plumbing in an engine room of a motor vehicle.

Since the past, a hose mainly composed of a tubular rubber layer has been widely used in a variety of industrial and automotive applications. Main purpose of applying such rubber hose is for absorption of vibration.

For example, in case of plumbing hose to be arranged in an engine room of a motor vehicle, the plumbing hose serves as to absorb engine vibration, compressor vibration of an air conditioner (in case of a hose for conveying refrigerant, namely an air conditioning hose) and other various vibration generated during car driving, and to restrain transmission of the vibration from one member to the other member which is joined with the one member via the plumbing hose.

Meanwhile, regardless of industrial or automotive applications, hoses for oil system, fuel system, water system and refrigerant system have multi-layered construction including inner surface rubber layer, outer surface rubber layer and reinforcing layer interposed between the inner and outer surface rubber layers, for example, as disclosed in the Patent Document No. 1 below. The reinforcing layer is constructed by braiding reinforcing yarns (reinforcing wire member).

FIG. 8(A) shows construction of a refrigerant conveying hose (air conditioner hose) which is disclosed in the Patent Document 1 below. Reference numeral 200 in FIG. 8(A) indicates a tubular inner surface rubber layer. Resin inner layer 202 is formed in and laminated over an inner surface of the inner surface rubber layer 200. And, first reinforcing layer 204 is formed or laminated on an outer side of the inner surface rubber layer 200, and second reinforcing layer 206 is formed or laminated on an outer side of the first reinforcing layer 204 with intervening intermediate rubber layer 208 between the first and the second reinforcing layers 204, 206. The first reinforcing layer 204 is formed by spirally winding reinforcing yarn or yarns while the second reinforcing layer 206 is formed by spirally winding reinforcing yarn or yarns in the reverse direction to the winding direction of the first reinforcing layer 204. Further, outer surface rubber layer 210 of outermost layer, which serves as cover layer, is formed or laminated on outer side of the second reinforcing layer 206.

In this example, the reinforcing layers 204, 206 are formed by spirally arranging or winding reinforcing yarns. On the other hand, such reinforcing layer is also formed by braiding reinforcing yarns.

FIG. 8(B) shows an example of a hose having such braided reinforcing layer. Reference numeral 212 in FIG. 8(B) indicates reinforcing layer which is formed by braiding reinforcing yarns between the inner surface rubber layer 200 and the outer surface rubber layer 210.

Even in this example, the resin inner layer 202 is also formed in and laminated over an inner surface of the inner surface rubber layer 200.

Meanwhile, in case of such straight-sided tubular hose, in the past the hose has been required to have a predetermined length in order to ensure favorable vibration absorbing property.

In particular, compared to low-pressure hoses for fuel system, water system or the like, a longer length is required for high pressure hoses for oil system (for example, power steering system), refrigerant system (refrigerant conveying system) or the like to absorb vibration and reduce transmission of noise and vibration to vehicle interior, commensurate with rigidity of the hoses.

For example, in case of refrigerant conveying hose, typically the hose of 300 mm to 600 mm in length is adapted to absorb vibration and reduce transmission of noise and vibration, even for plumbing or piping for direct distance of 200 mm.

However, an engine room is crammed with variety of components and parts. And, specifically in these days, an engine room has been designed in more and more compact size. Therefore, under the circumstances, if a long hose is arranged in the engine room, it bothers an design engineer to design plumbing arrangement to avoid interference with other components or parts and an operator to handle the hose when arranging the hose in the engine room. Further, such plumbing design and handling of the hose according to a type of motor vehicles should be devised. These result in excessive work load.

In view of foregoing aspects, it is demanded to develop a hose that has a short length and can absorb vibration favorably.

As for one of the means to design the hose in short length while securing vibration absorbing property, it is assumed to form the hose with corrugations.

When the hose is formed with corrugations, flexibility of the hose is drastically improved. However, once high pressure is exerted internally to the hose by fluid, the hose is entirely elongated largely in an axial direction.

In this instance, when the hose is in a fixed state at opposite ends thereof (usually a hose is applied in this manner), the hose is entirely curved largely and there caused a problem of interference with other components and parts around the hose.

As a conclusion, it is not a sufficient countermeasure to provide the hose with corrugation.

Meanwhile, in case of a high pressure hose such as an air conditioning hose, when a high pressure is exerted to the hose by a fluid directed in the inside thereof, the hose and the fluid work together and exhibit the rigid-body like behavior much more than when such high pressure is not exerted to the hose.

The larger the cross-sectional area of the hose including the fluid is, the greater the degree of the rigidity is.

That is, the smaller the cross-sectional area of the hose including the fluid is, the less the degree of the rigidity is, resulting that the vibration absorbing property is increased by just that much.

Therefore, in order to design a hose non-corrugated and short in length while enhancing vibration absorbing property of the hose, it is effective means to form the hose with small diameter.

However, if a hose is formed just slim entirely including axial end portions of the hose, specifically in a case of a pressure resistant hose having a reinforcing layer, insertability of an insert pipe is significantly lowered when the insert pipe of a joint fitting is inserted in the hose, and mounting of the joint fitting is attended with much difficulty due to resistance of the reinforcing layer.

It is conceived as a counter measure to diametrically enlarge axial end portions of the hose preparedly prior to mounting operation of the joint fitting, namely the portion to be swaged or compressed (the swaged portion).

For example, with regard to a water system hose such as radiator hose, the Patent Documents 2 and 3 below disclose that a mandrel is inserted in an end portion of non-vulcanized rubber which is formed by extrusion, and the rubber is vulcanized and formed in this state to form a large diameter end portion, namely a diametrically enlarged hose end portions.

However, in this case, additional step is required as preliminary step for diametrically enlarging the hose end portion. Besides, there is a problem that diametrically enlarging of the hose end portions is attended with also difficulty.

In such water system hose as disclosed in the Patent Documents 2 and 3, a bursting pressure is small and braid or winding density of a reinforcing layer is low, about 15 to 25%. In this case, the difficulty lies not so much in diametrically enlarging the hose end portions. However, in a high-pressure hose where a bursting pressure is 1 MPa or more, specifically 5 MPa or more, or 10 MPa or more, or where a braid or winding density of a reinforcing layer is 50% or more, resistance of the reinforcing layer is remarkably increased, resulting that the degree of the difficulty becomes high in diametrically enlarging the hose end portion.

In order to diametrically enlarge the end portion of the rubber hose which is unvulcanized but has been already provided with a reinforcing layer by inserting a mandrel in the end portion thereof, for example, a braid or winding angle of reinforcing yarn should be decreased sufficiently with respect to a neutral angle to reduce resistance of the reinforcing layer. Due to such reason, there occurs also a problem that an acceptable range of the braid or winding angle of the reinforcing yarn is largely restricted in the reinforcing layer.

Besides, whether diametrically enlarging preparedly an end portion of a rubber hose that has been formed first in straight-sided cylindrical shape or diametrically enlarging an end portion of a rubber hose by inserting an insert pipe therein in course of mounting of a joint fitting to the rubber hose, diametrically enlarging operation entails a difficult problem that axial end portion of the hose, namely swaged portions become thin-walled.

For the swaged or compressed portion of the axial end portion of the hose, swaging or compressing rate is usually required to be set about 25 to 50%, considering varied wall-thickness of portions to be swaged or compressed, or fastening strength for a portion to be swaged or compressed. If the wall-thickness of the portion to be swaged is thin, the portion happen to be broken by swaging or compressing operation.

In order to prevent this problem, the portion to be swaged, i. e, the swaged or compressed portion is required to have wall-thickness of a certain thickness or larger than the certain thickness. However, when diametrically enlarging the axial end portion of the hose that has been first formed by extruding into a straight-sided cylindrical shape, it is difficult to provide the hose with required wall-thickness.

In other words, if the hose is such type that the joint fitting is securely swaged on the axial end portion of the hose, it is difficult to apply a technique to diametrically enlarging the axial end portion as stated (incidentally, the hoses disclosed in the Patent Documents 2 and 3 are not such type that the joint fitting is securely swaged on the end portion of the hose).

| | |
|---|---|
| [Patent Document 1] | JP, A, 7-68659 |
| [Patent Document 2] | JP, B, 3244183 |
| [Patent Document 3] | JP, B, 8-26955 |

Under the circumstances described above, it is an object of the present invention to provide a novel pressure resistant vibration absorbing hose of such type that a joint fitting is securely swaged onto axial end portion thereof. In the novel pressure resistant vibration absorbing hose according to the present invention, for example, the axial end portion of the hose do not happen to be broken in course of swaging of the joint fitting, and mounting of the joint fitting is not attended with difficulty.

### SUMMARY OF THE INVENTION

According to the present invention, there is provided a novel pressure resistant vibration absorbing hose comprises a hose body and a joint fitting. The hose body has an inner surface layer, a reinforcing layer formed on an outer side of the inner surface layer by braiding or spirally winding reinforcing wire member (including reinforcing yarn and reinforcing filament member, etc.) and an outer surface layer as cover layer on an outer side of the reinforcing layer. The hose body has a swaged or compressed portion (i.e., to-be-swaged portion or to-be-compressed portion) on an axial end portion thereof and a main portion other than the swaged portion. The inner surface layer and the outer surface layer also has a swaged portion and a main portion corresponding to the swaged portion and the main portion of the hose body, respectively. The joint fitting is attached to the swaged portion of the hose body. The joint fitting has a rigid insert pipe and a sleeve-like socket fitting. The joint fitting is securely fixed to the swaged portion by securely swaging the socket fitting to the swaged portion in a diametrically contracting direction while the insert pipe is inserted within the swaged portion and the socket fitting is fitted on an outer surface of the swaged portion. The inner surface layer is formed so as to have a large diameter at the swaged portion of the axial end portion, and a relatively smaller diameter at the main portion with respect to the swaged portion, at forming (for example, molding), for example, so as to have a large inner diameter at the swaged portion thereof, and a relatively smaller inner diameter at the main portion with respect to the swaged portion. The inner surface layer has a wall thickness t₁ at the main portion and a wall thickness t₂ at the swaged portion, and the wall thickness t₁ and the wall thickness t₂ have a relationship of t₂> or =t₁ in a state before the joint fitting is securely swaged to the hose body, namely in a formed state (for example, molded state) before the joint fitting is securely swaged thereto. The reinforcing layer and the outer surface layer are formed on outer side of the inner surface layer so as to follow a shape of an outer surface of the inner surface layer, for example, after formed (for example, molded). The wall thickness t₂ at the swaged portion may be equal to or larger than 1.3 times the wall thickness t₁ at the main portion in the state before the joint fitting is securely swaged to the hose body, for example, in the formed state (for example, molded state) before the joint fitting is securely swaged thereto. An inner diameter of the insert pipe may be designed equal to or generally equal to an inner diameter of the inner surface layer at the main portion. The inner surface layer may be formed such that an inner diameter thereof at the swaged portion is equal to or larger than 1.3 times an inner diameter thereof at the main portion, at forming (for example, molding). The hose body may be formed such that an outer diameter of the swaged portion is designed larger than an outer diameter of the main portion in the state before the joint fitting is securely swaged to the hose body, for example, in the formed state before the joint fitting is securely swaged thereto. The inner surface layer may include a tapered portion between the swaged portion and the main portion and the tapered portion diametrically contracts toward the main portion.

In the pressure resistant vibration absorbing hose, a bursting pressure of the pressure resistant vibration absorbing hose under pressure may be 1 MPa or more.

The reinforcing layer may be formed by braiding or spirally winding the reinforcing wire member (including reinforcing yarn and reinforcing filament member, etc.) with braid or winding density of 50% or more.

The outer surface layer may be formed such that the wall thickness thereof at the swaged portion is smaller than the wall thickness thereof at the main portion in a state before the joint fitting is securely swaged to the hose body, for example, in a formed state before the joint fitting is securely swaged thereto. The outer surface layer may also be formed from heat shrinkable tube.

According to one aspect of the present invention, there is provided a method for producing a pressure resistant vibration absorbing hose. The pressure resistant vibration absorbing hose comprises, for example, a hose body and a joint fitting. The hose body may have an inner surface layer, a reinforcing layer formed on an outer side of the inner surface layer by braiding or spirally winding reinforcing wire member (including reinforcing yarn and reinforcing filament member, etc.) and an outer surface layer as cover layer on an outer side of the reinforcing layer. The hose body may have a swaged or compressed portion (i.e., to-be-swaged portion or to-be-compressed portion) on an axial end portion thereof and a main portion other than the swaged portion. The joint fitting may be attached to the swaged portion of the hose body. The joint fitting may have a rigid insert pipe and a sleeve-like socket fitting. The joint fitting may be securely fixed to the swaged portion by securely swaging the socket fitting to the swaged portion in a diametrically contracting direction while the insert pipe is inserted within the swaged portion and the socket fitting is fitted on an outer surface of the swaged portion. The inner surface layer may be formed so as to have a large diameter at the swaged portion of the axial end portion, and a relatively smaller diameter at the main portion with respect to the swaged portion, at forming (for example, molding), for example, so as to have a large inner diameter at the swaged portion thereof, and a relatively smaller inner diameter at the main portion with respect to the swaged portion. The inner surface layer has a wall thickness t₁ at the main portion and a wall thickness t₂ at the swaged portion, and the wall thickness t₁ and the wall thickness t₂ may have a relationship of t₂> or =t₁ in a state before the joint fitting is securely swaged to the hose body, namely in a formed state (for example, molded state) before the joint fitting is securely swaged thereto. The reinforcing layer and the outer surface layer may be formed on outer side of the inner surface layer so as to follow a shape of an outer surface of the inner surface layer, for example, at forming (for example, molding). The method for producing the pressure resistant vibration absorbing hose according to the present invention comprises (a) a step of forming the inner surface layer separately or independently by molding, (b) a step of forming the reinforcing layer by braiding or spirally winding the reinforcing wire member on an outer side of the inner surface layer after the step of (a), and (c) a step of forming the outer surface layer after the step of (b).

An inner surface rubber layer as the inner surface layer may be vulcanized and formed separately by the molding in the step of forming the inner surface layer, and an outer surface rubber layer as the outer surface layer may be vulcanized after the outer surface rubber layer is formed so as to be laminated over the reinforcing layer in the step of forming the outer surface layer.

As stated above, in the hose of the present invention, the inner surface layer is formed (for example, molded) so as to have a following shape. Namely, the inner surface layer has a large diameter at the swaged portion of the axial end portion, and a relatively smaller diameter at the main portion other than the swaged portion with respect to the swaged portion, for example, so as to have a large inner diameter at the swaged portion thereof, and a relatively smaller inner diameter at the main portion with respect to the swaged portion. The reinforcing layer is formed so as to follow a shape of an outer surface of the inner surface layer, and the outer surface layer is formed on an outer side of the reinforcing layer, namely, the reinforcing layer and the outer surface layer are formed on an outer side of the inner surface layer so as to follow a shape of an outer surface of the inner surface layer in the steps of forming the reinforcing layer and forming the outer surface layer. The inner surface layer has a wall thickness t₁ at the main portion and a wall thickness t₂ at the swaged portion and the wall thickness t₁ and the wall thickness t₂ have a relationship of t₂> or =t₁ in a state before the joint fitting is securely swaged to the hose body, or in the step of forming the inner surface layer. Therefore, according to the present invention, the insert pipe can be inserted in the swaged portion at the axial end portion of the hose body without specific difficulties and the joint fitting can be easily attached to the axial end portion of the hose body.

And, when the socket fitting is swaged onto the hose body in a diametrically contracting direction, the joint fitting is firmly securely swaged on the hose body without causing a breakage in the swaged portion by swaging operation as the swaged portion of the inner surface rubber layer has sufficient wall thickness.

In the above hose, the wall thickness t₁ of the inner surface layer at the main portion is preferably as thin-walled as possible in view of vibration absorbing property.

On the contrary, the inner surface layer preferably has a wall thickness t₁ of or above a certain thickness in order to satisfy requirements in permeation resistance to internal fluid and water impermeability and the like.

In this sense, the wall thickness t₁ at the main portion is preferably in the range of 1.0 to 2.5 mm, more preferably in the range of 1.3 to 2.0 mm.

On the other hand, the inner surface layer preferably has such a large diameter at the above swaged portion that an inner diameter of the insert pipe is equal to or generally equal to an inner diameter of the inner surface layer at the main portion when the insert pipe is inserted in the inner surface layer.

When the inner diameter of the insert pipe is equal to or generally equal to the inner diameter of the inner surface layer at the main portion, a cross-sectional area of a fluid path is generally constant along an entire length of the hose. So, there is no problem of pressure loss (drop) at an attached region of the joint fitting. And, even when the inner surface layer is formed thin at the main portion, it is possible to secure a required flow volume of fluid.

In the inner surface layer, the wall thickness t₂ at the swaged portion is preferably in a range of 1.3 to 3.0 mm, more preferably in a range of 1.5 to 2.5 mm in the above point of view.

Specifically, the present invention is preferably adapted for the hose with bursting pressure of 1 MPa or more, specifically 5 MPa or more or 10 MPa or more.

And, in particular, the present invention is preferably adapted for the hose having the reinforcing layer formed by braiding or spirally winding the reinforcing wire member with braid or winding density of 50% or more.

Here, the braid or winding density means a ratio of an area of the reinforcing wire member to an area of the reinforcing layer. When the reinforcing wire member is arranged without clearance or with zero clearance, the braid density or winding density is 100%.

A method for producing the pressure resistant vibration absorbing hose according to the present invention comprises a step of forming or molding the inner surface layer separately by molding, a following step of forming the reinforcing layer by braiding or spirally winding the reinforcing wire member on an outer side of the inner surface layer, and in a further following step of forming the outer surface layer.

According to the method disclosed in the above Patent Documents No. 2 and No. 3, unvulcanized rubber hose is first formed in a straight-sided cylindrical shape by extrusion, and then an axial end portion of the rubber hose is diametrically enlarged by inserting a mandrel therein. Unlike in this case, according to one aspect of the present invention, the inner surface layer is formed separately by molding. That means, the inner surface layer is formed or molded with diametrically enlarged axial end portion in a state before the reinforcing layer is formed. Therefore, the axial end portion of the inner surface layer may be extremely easily formed in diametrically enlarged shape without resistance imposed by the reinforcing layer.

And, according to one aspect of the present invention, as the reinforcing layer is formed in a following step, a braid or winding angle of the reinforcing wire member, a braid or winding density thereof, or the like in the reinforcing layer may be freely decided or set without considering diametrically enlarging operation of the axial end portion in a later step.

For example, in the present invention, the braid or winding density may be set 50% or more as stated above without specific consideration. And, the braid or winding angle may be set an angle near a neutral angle (54.7°), or within a range of the neutral angle plus or minus 3°, for example, 55°.

In the present invention, an inner surface rubber layer as the inner surface layer may be vulcanized and formed separately by the molding, then, an outer surface rubber layer as the outer surface layer may be vulcanized after the outer surface rubber layer is formed so as to be laminated over the reinforcing layer, for example, by extrusion.

According to the method of the present invention, wall thickness of the inner surface layer at the main portion and the swaged portion may be decided or set simply and freely.

The wording “mold” (including inflected forms such as “molding” and “molded”) indicates forming by using a mold, for example, a metal mold, and includes injection molding, compression molding, transfer molding and the like. The wording “an inner surface layer” indicates a rubber layer provided in an inner side of a reinforcing layer or reinforcing layer construction, namely “an inner surface rubber layer”. “The inner surface rubber layer” constitutes, for example, an innermost layer. “The outer surface layer” constitutes, for example, an outermost layer.

Now, the preferred embodiments of the present invention will be described in detail with reference to the drawings.

### BRIEF DESCRIPTION OF THE DRAWINGS

FIG. 1(A) is a view showing a hose according to one embodiment of the present invention.

FIG. 1(B) is a view showing a construction of a part B of FIG. 1(A).

FIG. 2 is an enlarged sectional view showing a relevant part of the hose according to the one embodiment.

FIG. 3 is an explanatory view showing one step of a method for producing the hose according to the one embodiment.

FIG. 4(A) is an explanatory view showing a step following the step of FIG. 3.

FIG. 4(B) is an explanatory view showing a step following the step of FIG. 4(A).

FIG. 5(A) is a cross-sectional view showing a hose body of the hose according to the one embodiment.

FIG. 5(B) is an enlarged explanatory view showing a part B of FIG. 5(A).

FIG. 6 is a view showing a method for test conducted for example and comparison example hoses.

FIG. 7 is a view showing a method for another test conducted for the example and comparison example hoses.

FIG. 8(A) is a view showing one type of a conventional hose.

FIG. 8(B) is a view showing another type of a conventional hose.

### DETAILED DESCRIPTIONS OF PREFERRED EMBODIMENTS

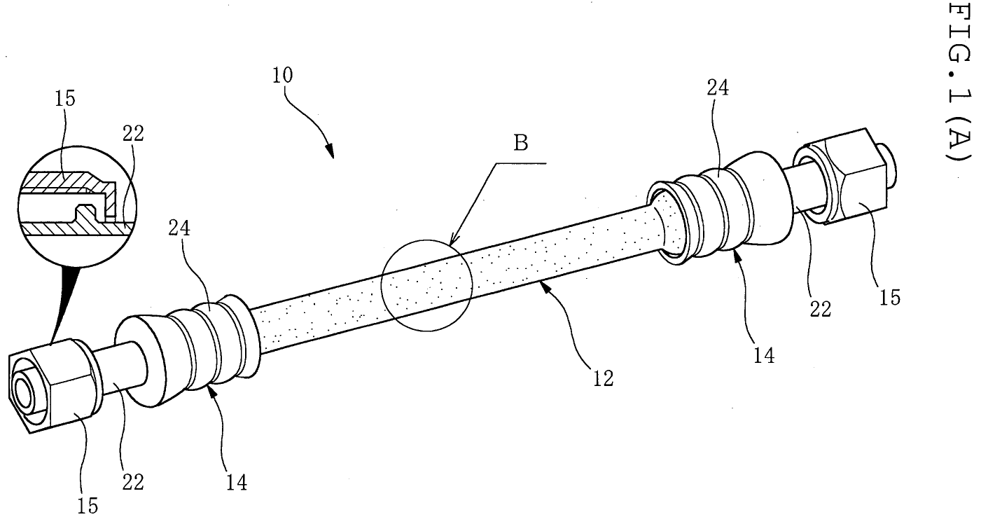

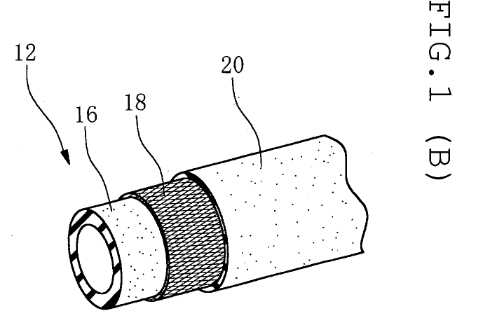

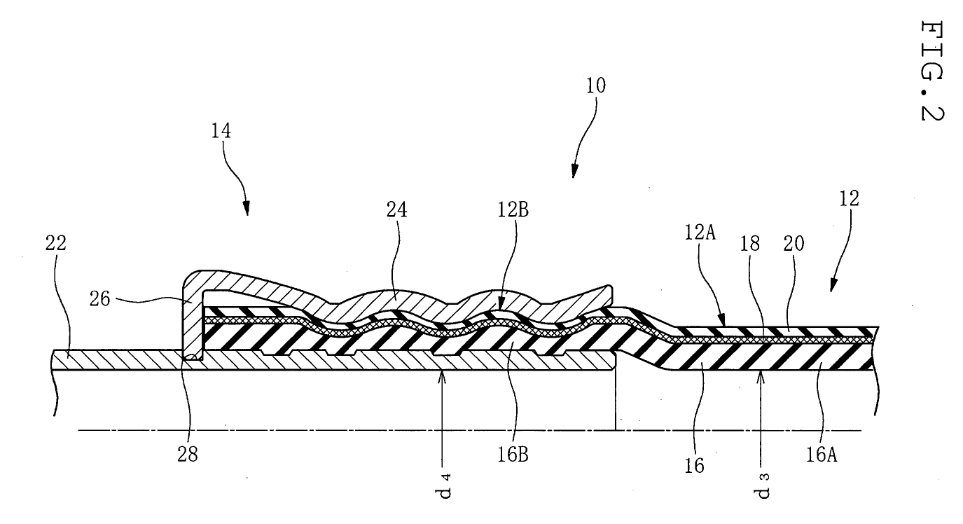

In FIGS. 1(A) and (B), reference numeral 10 indicates a pressure resistant vibration absorbing hose (hereinafter simply referred to as a hose), which is applied, for example, as refrigerant conveying hose (air conditioning hose) or the like, has a hose body 12 and a pair of joint fittings 14 which are securely swaged or compressed on swaged or compressed portions 12B on axial end portions thereof (refer to FIG. 2). As shown in FIG. 1(B), the hose body 12 has multi-layered construction, an inner rubber layer or inner surface rubber layer (inner surface layer) 16 of an innermost layer, a reinforcing layer 18 which is formed by braiding reinforcing yarn or reinforcing filament member (reinforcing wire member) on an outer side of the inner surface rubber layer 16, and an outer rubber layer or outer surface rubber layer (outer surface layer) 20 of an outermost layer as cover layer.

For the reinforcing yarns or filament members forming the pressure resistant reinforcing layer 18, polyethylene terephthalate (PET), polyethylene naphthalate (PEN), aramid, polyamide or nylon (PA), vynilon, rayon, metal wire or the like may be adapted.

The inner surface rubber layer 16 may be formed from isobutylene-isoprene rubber (IIR), halogenated IIR (chloro-IIR (Cl-IIR or CIIR), bromo-IIR (Br-IIR or BIIR)), acrylonitrile-butadiene-rubber (NBR), chloroprene rubber (CR), ethylene-propylene-diene-rubber (EPDM), ethylene-propylene copolymer (EPM), fluoro rubber (FKM), epichlorohydrin rubber or ethylene oxide copolymer (ECO), silicon rubber, urethane rubber, acrylic rubber or the like. These materials are applied in single or blended form for the inner surface rubber layer 16.

However, in case where the hose 10 is applied for hydrofluorocarbon (HFC) type refrigerant conveying hose, specifically IIR or halogenated IIR in single or blended form may be preferably used.

The outer surface rubber layer 20 may be formed also from every kind of rubber materials cited above as material for the inner surface rubber layer 16. In addition, heat-shrinkable tube and thermoplastic elastomer (TPE) are also applicable for the outer surface rubber layer 20. As for material of such heat-shrinkable tube and TPE, acrylic type, styrene type, olefin type, diolefin type, polyvinyl chloride type, urethane type, ester type, amide type, fluorine type or the like may be applied.

As shown in FIG. 2, the above joint fitting 14 has a rigid metal insert pipe 22 and a sleeve-like socket fitting 24. The insert pipe 22 is inserted in the swaged portion 12B of an axial end portion of the hose body 12, the socket fitting 24 is fitted on an outer surface of the swaged portion 12B. Then, the socket fitting 24 is swaged in a diametrically contracting direction, and securely swaged on the swaged portion 12B. The joint fitting 14 is thereby securely swaged on the hose body 12 while the swaged portion 12B is clamped in an inward and outward direction by the socket fitting 24 and the insert pipe 22.

Here, the socket fitting 24 includes an inwardly directed annular stop portion 26. An inner peripheral end portion of the stop portion 26 is fitted and stopped in an annular stop groove 28 in an outer peripheral surface of the insert pipe 22.

Reference numeral 15 in FIG. 1(A) indicates a hexagon cap nut or a mounting nut which is rotatably mounted on the insert pipe 22.

As shown in FIG. 2, in this embodiment, an inner diameter of a main portion 12A of the hose body 12, specifically an inner diameter d₃ of the inner surface rubber layer 16 at the main portion 12A (a main portion 16A of the inner surface rubber layer 16) and an inner diameter d₄ of the insert pipe 22 are designed identical.

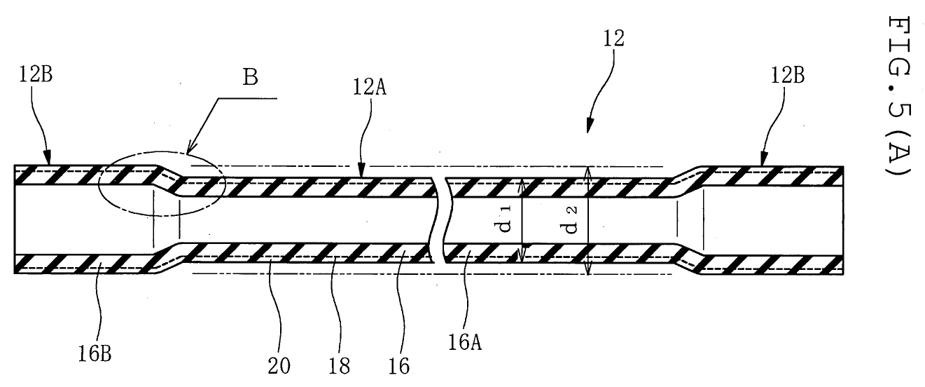

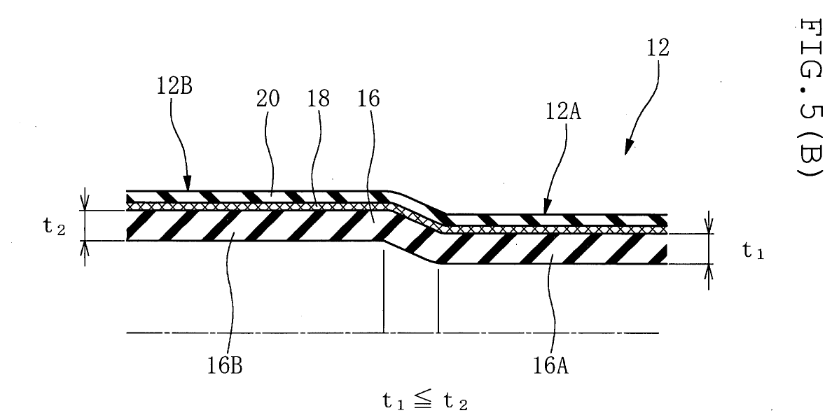

FIG. 5(A) shows a shape of the hose body 12 before the joint fitting 14 is securely swaged thereon.

In FIG. 5(A), reference numeral 12A indicates the main portion of the hose body 12, and reference numeral 12B indicates a swaged portion or to-be-swaged portion on an axial end portion thereof As shown in FIG. 5(A), in this embodiment, an outer diameter d₁ of the main portion 12A is smaller than an outer diameter d₂ of the swaged portion 12B.

That is, although an outer diameter of a main portion of a hose body is designed the same as an outer diameter of a swaged portion of the hose body in a conventional hose of this type, only the main portion 12A is formed with small diameter in this embodiment. An inner diameter of the main portion 12A is smaller than an inner diameter of the swaged portion 12B.

As a result, the swaged portion 12B is larger in diameter than the main portion 12A.

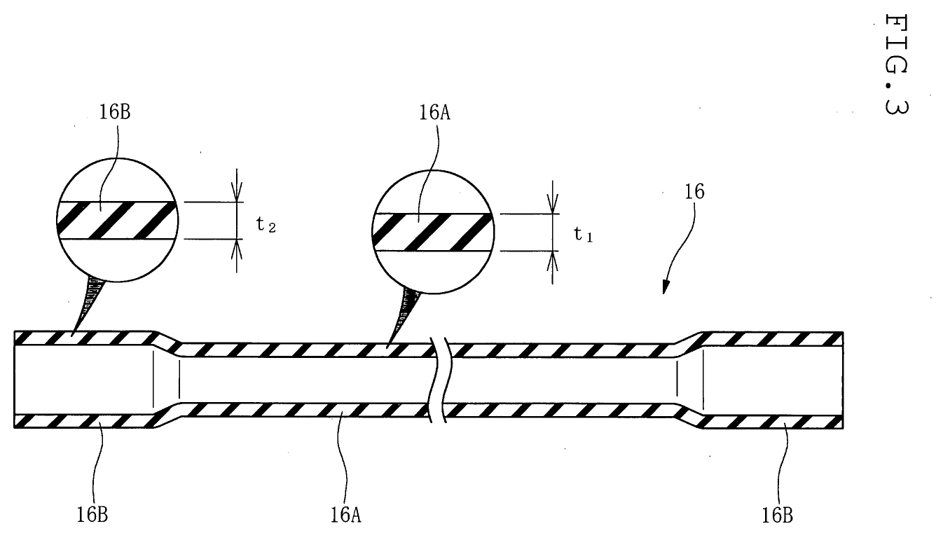

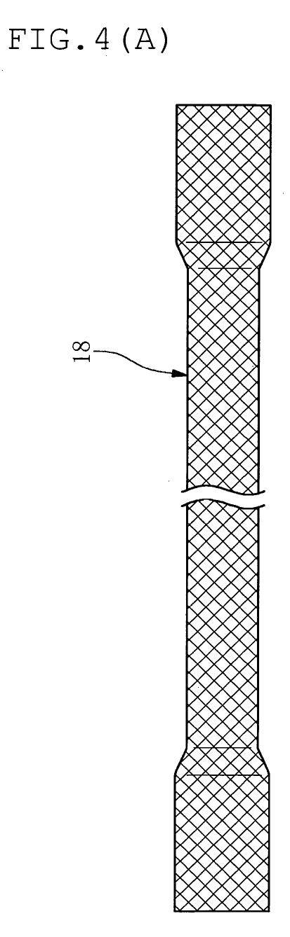

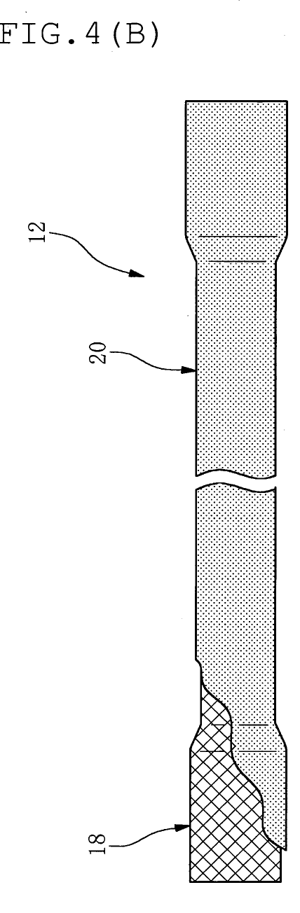

FIGS. 3, 4(A) and 4(B) show a method for producing the hose 10 in this embodiment. According to this method as shown in FIG. 3, first the inner surface rubber layer 16 is formed or molded independently by injection molding. The inner surface rubber layer 16 may be formed also by compression molding, transfer molding or the like.

In FIG. 3, reference numeral 16A indicates a main portion of the inner surface rubber layer 16 and reference numeral 16B indicates a swaged portion thereof (the inner surface rubber layer 16 at the swaged portion 12B).

As shown in FIG. 3, in this embodiment, the inner surface rubber layer 16 is formed or molded by injection molding such that the swaged portion 16B is larger in diameter than the main portion 16A.

Here the swaged portion 16B has a diametrically large shape or large diameter so as to facilitate easy insertion of the insert pipe 22 therein.

In the inner surface rubber layer 16, a wall thickness t₂ of the swaged portion 16B is equal to or larger than a wall thickness t₁ of the main portion 16A, namely t₂> or =t₁.

And here, the wall thickness t₁ of the main portion 16A is designed in a range of 1.0 to 2.5 mm, more preferably 1.3 to 2.0 mm in order to provide the hose 10 with favorable vibration absorbing property or vibration damping property, and on the other hand, in order to provide the hose 10 with impermeability of an internal fluid or water impermeability.

On the other hand, the wall-thickness t₂ of the swaged portion 16B is designed in a range of 1.3 to 3.0 mm, more preferably in a range of 1.5 to 2.5 mm so as not to cause breakage by securely swaging operation in the swaged portion 16B when the joint fitting 14 is swaged onto the hose body 12 at a swaging rate or compressing rate of 25 to 50%.

In the production method adapted in this embodiment, after the inner surface rubber layer 16 is vulcanized and formed separately or independently by applying injection molding or by injection molding as stated above, subsequently reinforcing yarn or reinforcing filament member is braided along a shape of an outer surface thereof to laminate and form the reinforcing layer 18 on an outer surface of the inner surface rubber layer 16 (refer to FIG. 4(A)).

Then, as shown in FIG. 4(B), unvulcanized outer surface rubber layer 20 is formed and laminated over an outer surface of the reinforcing layer 18.

And the unvulcanized outer surface rubber layer 20 is vulcanized by heating.

Meanwhile, heat-shrinkable tube may be applied for the outer surface rubber layer 20. With use of the heat-shrinkable tube, the outer surface rubber layer 20 may be formed in the following manner. The heat-shrinkable tube is formed by extrusion at a uniform thickness (circumference). Then, the heat-shrinkable tube is shrank by agency of heat, and thereby the outer surface rubber layer 20 is formed so as to follow the shape of the outer surface of the inner surface rubber layer 16.

According to the embodiment as stated above, no specific difficulty accompanies in inserting the insert pipe 22 in the swaged portion 12B of the axial end portion of the hose body 12. And, the insert pipe 22 can be easily inserted therein and the joint fitting 14 can be simply attached onto the axial end portion of the hose body 12.

When the socket fitting 24 is swaged onto the hose body 12 in a diametrically contracting direction, the joint fitting 14 is firmly securely swaged on the hose body 12 without causing a breakage in the swaged portion 16B by swaging operation as the swaged portion 16B of the inner surface rubber layer 16 has sufficient wall thickness.

And, in this embodiment, as an inner diameter d₄ Of the insert pipe 22 and the inner diameter d₃ of the main portion 16A of the inner surface rubber layer 16 are the same, fluid path including the joint fitting 14 and the main portion 16A has substantially constant sectional area. Therefore, there occurs no problem of pressure loss in a region of the joint fitting 14 when the joint fitting 14 is attached to the hose body 12, and fluid flow volume may be secured as required although the main portion 16A of the inner surface rubber layer 16 is formed slim.

According to the method stated here for producing the hose 10, the inner surface rubber layer 16 is vulcanized and formed separately by injection molding, and a reinforcing yarn is braided on an outer side of the inner surface rubber layer 16 to form the reinforcing layer 18 in the following step. And, as the outer surface rubber layer 20 is formed in a further following step to make the hose 10, specifically the hose body 12, wall thickness t₁, t₂ of the main portion 16A, and the swaged portion 16B in the inner surface rubber layer 16 may be designed easily and freely.

In this embodiment, the reinforcing layer 18 is formed after the inner surface rubber layer 16 is formed or molded with large diameter on the axial end portion thereof. Therefore, with regard to the reinforcing layer 18, braid angle of reinforcing yarn, braid density of reinforcing yarn or the like can be designed freely without considering later operation of diametrically enlarging the axial end portion.

### EXAMPLE

Some example and comparison example hoses are formed having different constructions as shown in Table 1, and evaluated with respect to vibration 15 absorbing property, refrigerant permeability, water permeability, bursting pressure at high temperature and bursting pressure at room temperature (RT), respectively. The results are shown in Table 1.

TABLE 1

| | | | Examples | | |
|---|---|---|---|---|---|
| | | | 1 | 2 | 3 |
| Main | Dimension | Inner diameter | 9.0 | 9.0 | 9.0 |
| portion | | Outer diameter | 15.5 | 13.5 | 13.1 |
| | Inner surface | Material | C1-IIR | C1-IIR | C1-IIR |
| | layer | Wall thickness (t₁) | 2.0 | 1.0 | 0.8 |
| | Reinforcing | Material | PET | PET | PET |
| | layer | No. of denier | 1000 de | 1000 de | 1000 de |
| | | No. of yarns | 3 yarns × 48 | 2 yarns × 48 | 2 yarns × 48 |
| | | | carriers | carriers | carriers |
| | | Braid density (%) | 83 | 71 | 74 |
| | Outer surface | Material | EPM | EPM | EPM |
| | layer | Wall thickness | 0.75 | 0.75 | 0.75 |
| | Dimension | Inner diameter | 12.0 | 12.0 | 12.0 |
| | | Outer diameter | 18.4 | 16.8 | 16.8 |
| Swaged | Inner surface | Wall thickness | 2.0 | 1.3 | 1.3 |
| portion | layer | (t₂) | | | |
| | Outer surface | Wall thickness | 0.7 | 0.6 | 0.6 |
| | layer | | | | |
| Relationship between t₁ and t₂ | | | t₁ = t₂ | t₁ < t₂ | t₁ < t₂ |
| Free length of hose (length of main portion) | | | 150 mm | 150 mm | 150 mm |
| Swaging rate (compressing rate to a total wall | | | 40% | 40% | 40% |
| thickness) | | | | | |
| Vibration absorbing property | | | Circle | Double circle | Double circle |
| Refrigerant permeability (g/(hose · 72 hrs)) | | | 0.5 | 0.7 | 0.9 |
| Water permeability (g/(hose · 168 hrs)) | | | 0.1 | 0.2 | 0.3 |
| Bursting pressure at high temperature | | | 13.7 | 10.8 | 2.9 |
| (100° C.) (MPa) | | | Pinhole near | Pinhole near | Pinhole in main |
| | | | swaged portion | swaged portion | portion |
| Property of swaged portion | | | Circle | Circle | Circle |
| (rubber breakage) | | | | | |
| Bursting pressure at RT (MPa) | | | 27.2 | 25.6 | 26.1 |
| | | | Comparison Examples | | |
| | | | A | B | |
| Main | Dimension | Inner diameter | 9.0 | 12.0 | |
| portion | | Outer diameter | 14.1 | 19.0 | |
| | Inner surface | Material | C1-IIR | PA6/C1-IIR | |
| | layer | Wall thickness (t₁) | 1.3 | 1.45 | |
| | Reinforcing | Material | PET | PET | |
| | layer | No. of denier | 1000 de | 2000 de | |
| | | No. of yarns | 2 yarns × 48 | 4 yarns × 24 | |
| | | | carriers | carriers | |
| | | Braid density (%) | 67 | 109 | |
| | Outer surface | Material | EPM | EPDM | |
| | layer | Wall thickness | 0.75 | 1.20 | |
| | Dimension | Inner diameter | 12.0 | | |
| | | Outer diameter | 16.2 | | |
| Swaged | Inner surface | Wall thickness | 1.0 | Same as the | |
| portion | layer | (t₂) | | main portion | |
| | Outer surface | Wall thickness | 0.6 | | |
| | layer | | | | |

| | | | |
|---|---|---|---|
| Relationship between t₁ and t₂ | t₁ > t₂ | t₁ = t₂ | |
| Free length of hose (length of main portion) | 150 mm | 450 mm | |
| Swaging rate (compressing rate to a total wall | 40% | 40% | Target value |
| thickness) | | | |

| | | Circle | Same level |
|---|---|---|---|
| Vibration absorbing property | Double circle | (standard) | as B |
| Refrigerant permeability (g/(hose · 72 hrs)) | 0.6 | 0.7 | 0.7 |
| Water permeability (g/(hose · 168 hrs)) | 0.2 | 0.2 | 0.2 |
| Bursting pressure at high temperature | 4.9 | 14.7 | 9.8 MPa or |
| (100° C.) (MPa) | | | more |

| | Rubber | | |
|---|---|---|---|
| | breakage in | | |
| | swaged | Hose coming | |
| Property of swaged portion | portion | off | |
| (rubber breakage) | Cross | Circle | — |
| Bursting pressure at RT (MPa) | 23.5 | 28.1 | 9.8 MPa or |
| | | | more |

Note: *1) Inner diameter, outer diameter and wall-thickness are indicated in mm in Table 1.
*2) Density: Yarn area ratio to an outer surface area of inner surface rubber layer. Density = (yarn width × No. of yarns/(2 × π × outer diameter of an inner surface rubber layer × cos braid angle) ) × 100
*3) “Circle” indicates good, “double circle” indicates superior, and “cross” indicates inferior in Table 1.

In the line “No. of yarns” of the reinforcing layer of each of example and comparison example hoses in Table 1, “3 yarns×48 carriers”, 2 yarns×48 carriers” “4 yarns×24 carriers” mean that 3, 2 or 4 parallel reinforcing yarns of 1000 denier (de) or 2000 de are braided on an 48 or 24 carrier machine.

The phrase “same level as B” in the column of “Target value” means the level of vibration absorbing property of a hose with inner diameter of 12 mm and free length of 450 mm.

In Table 1, the vibration absorbing property, refrigerant permeability, water permeability, bursting pressure at high temperature and bursting pressure at RT are measured under the following conditions.

[Vibration Absorbing Property]

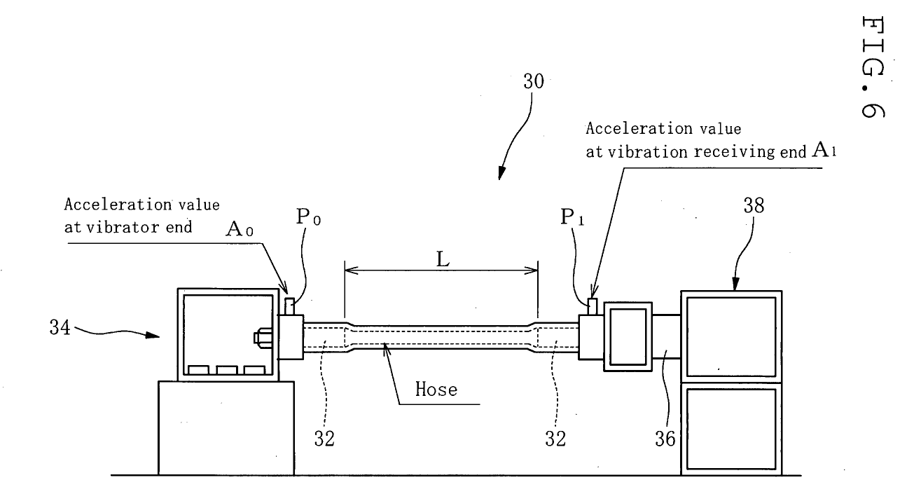

Meanwhile, the vibration absorbing property is evaluated by means of a measuring equipment 30 shown in FIG. 6.

Specifically, each hose or hose body of Examples 1, 2, 3 and Comparison Examples A, B is set on the measuring equipment 30 with opposite ends thereof being supported by metal cores 32, 32 respectively. And, while one end of the hose or hose body is vibrated by a vibrator 34 and the other end of the hose or hose body receives vibration, acceleration value A₀ at a vibrator end is measured at measuring point P₀ of a vibrator end and acceleration value A₁ at a vibration receiving end is measured at measuring point P₁ of a vibration receiving end respectively. Then vibration transfer functions or transfer functions are evaluated based on these values.

In FIG. 6, numeral reference 36 indicates a rubber member and numeral reference 38 a platen box.

[Refrigerant Permeability]

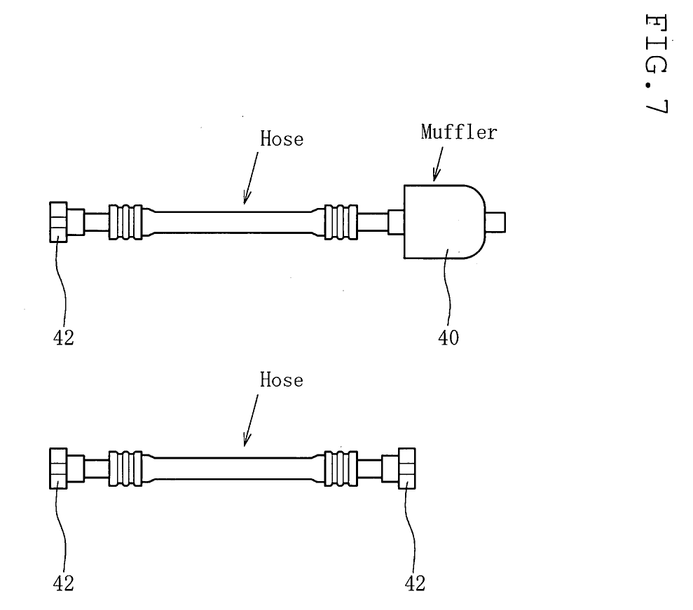

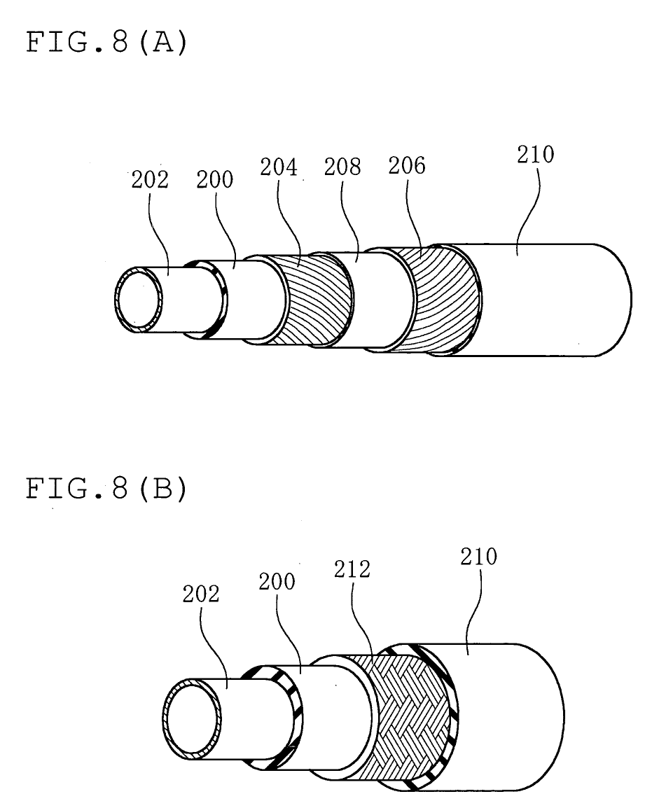

As shown in FIG. 7, four hoses are prepared per each of example and comparison example hoses. Each of the three hoses is connected to muffler 40 with capacity of 50 cc at one end, is filled with a liquid refrigerant HFC-134a to 70% of a total capacity of the hose and the muffler 40, while being closed at the other end with a cap 42.

The rest one hose does not contain HFC-134a for checking weight change of a single hose or a hose itself, and is closed at both ends with the caps 42 as shown in FIG. 7, and in this state, weight change of the single hose is evaluated.

The hoses are placed in an oven at 90° C. and weight of the single hose and the hoses containing the refrigerant are measured every 24 hours for 96 hours, and refrigerant permeation amount per hose is calculated in or based on the following formula:
[lost weight of the hose enclosed with refrigerant (96 hours−24 hours)]−lost weight of the single hose (96 hours−24 hours)]

The refrigerant permeation amount is favorably as small as possible. Here, a value of 0.7 g/(hose·72 hours) is targeted.

[Water Permeability]

After the example and comparison example hoses are dried at 100° C. for 24 hours, a drying agent is enclosed in each of the hoses in volume of 70% of an inner capacity of the hose.

Then water permeation amount per hose is calculated by or based on weight change of the drying agent after the hose is treated at 60° C. in 95% relative humidity (RH) for 168 hours.

[Bursting Pressure at High Temperature]

Bursting pressure at high temperature indicates a pressure value which causes a hose to burst-under the following condition. Each of the example and comparison example hoses is attached to a bath containing oil of 100° C. and is let stand for 30 minutes. Then a pressure is exerted to the hose while being kept for 30 seconds at every pressure raised by 0.98 MPa until the hose bursts. The bust pressure of each of the hose is recorded.

[Bursting Pressure at Room Temperature]

Bursting pressure at RT indicates water pressure value which causes a hose to burst when water pressure is exerted at room temperature internally to the hose at pressure rising speed of 160 Mpa/minute.

As seen in the results in Table 1, in the example hoses of the preferred embodiment, there is no break caused by swaging operation at the swaged portion 16B, fastening strength between the hose body 12 and the joint fitting 14 is large, internal pressure causes neither a disconnection of the hose body 12 from the joint fitting 14 nor a problem of rubber breakage at the swaged portion 16B, due to the result that the wall thickness t₂ of the swaged portion 16B is designed equal to or larger than the wall thickness t₁ of the main portion 16A in the inner surface rubber layer 16.

And, the vibration absorbing property is also favorable due to the result that the main portion 16A of the inner surface rubber layer 16 and the main portion 12A of the hose body 12 are designed to have smaller outer diameter in each example hose.

In addition, values of the refrigerant permeability and the water permeability are favorable in each example hose.

With regard to the Example 3, the value of the bursting pressure at high temperature is low. This is due to the pinhole formed in the main portion 16A, not due to the problem with the swaged portion 16B of the inner surface rubber layer 16 in itself.

In the Example 3, the inner surface rubber layer 16 has a wall thickness smaller than 1.0 mm on the main portion 16A. As seen from the result of the Example 3, the wall thickness t₁ of the main portion 16A of the inner surface rubber layer 16 is favorably designed 1.0 mm or more.

Although the preferred embodiments have been described above, these are only some of embodiments of the present invention.

For example, depending on circumstances, the reinforcing layer 18 may be formed by spirally winding reinforcing yarn or yarns. Moreover, configuration of the hose 10 may be varied for many purposes in the present invention. The present invention may be constructed and embodied in various configurations and modes within the scope of the present invention.

We claim:

1. A pressure resistant vibration absorbing hose, comprising:
a hose body having an inner surface layer, a reinforcing layer formed on an outer side of the inner surface layer by braiding or spirally winding reinforcing wire member and an outer surface layer as cover layer on an outer side of the reinforcing layer, the hose body having a swaged portion on an axial end portion thereof and a main portion other than the swaged portion,
a joint fitting attached to the swaged portion of the hose body, the joint fitting having a rigid insert pipe and a sleeve-like socket fitting, the joint fitting being securely fixed to the swaged portion by securely swaging the socket fitting to the swaged portion in a diametrically contracting direction while the insert pipe is inserted within the swaged portion and the socket fitting is fitted on an outer surface of the swaged portion,
the inner surface layer being formed so as to have a large diameter at the swaged portion of the axial end portion and a relatively smaller diameter at the main portion with respect to the swaged portion, at forming, the inner surface layer having a wall thickness t₁ at the main portion and a wall thickness t₂ at the swaged portion, the wall thickness t₁ and the wall thickness t₂ having a relationship of t₂> or =t₁ in a state before the joint fitting is securely swaged to the hose body, and
the reinforcing layer and the outer surface layer being formed on outer side of the inner surface layer so as to follow a shape of an outer surface of the inner surface layer.

2. The pressure resistant vibration absorbing hose as set forth in claim 1, wherein the inner surface layer is formed such that the wall thickness t₂ at the swaged portion is equal to the wall thickness t₁ at the main portion in a state before the joint fitting is securely swaged to the hose body.

3. The pressure resistant vibration absorbing hose as set forth in claim 1, wherein the inner surface layer is formed such that the wall thickness t₂ at the swaged portion is larger than the wall thickness t₁ at the main portion in a state before the joint fitting is securely swaged to the hose body.

4. The pressure resistant vibration absorbing hose as set forth in claim 3, wherein the wall thickness t₂ at the swaged portion is equal to or larger than 1.3 times the wall thickness t₁ at the main portion in the state before the joint fitting is securely swaged to the hose body.

5. The pressure resistant vibration absorbing hose as set forth in claim 1, wherein an inner diameter of the insert pipe is designed equal to or generally equal to an inner diameter of the inner surface layer at the main portion.

6. The pressure resistant vibration absorbing hose as set forth in claim 1, wherein the inner surface layer is formed such that an inner diameter thereof at the swaged portion is equal to or larger than 1.3 times an inner diameter thereof at the main portion, at forming.

7. The pressure resistant vibration absorbing hose as set forth in claim 1, wherein the outer surface layer is formed such that the wall thickness thereof at the swaged portion is smaller than the wall thickness thereof at the main portion in a state before the joint fitting is securely swaged to the hose body.

8. The pressure resistant vibration absorbing hose as set forth in claim 1, wherein an outer diameter of the swaged portion of the hose body is designed larger than an outer diameter of the main portion thereof in a state before the joint fitting is securely swaged to the hose body.

9. The pressure resistant vibration absorbing hose as set forth in claim 1, wherein the inner surface layer includes a tapered portion between the swaged portion and the main portion and the tapered portion diametrically contracts toward the main portion.

10. The pressure resistant vibration absorbing hose as set forth in claim 1, wherein the outer surface layer is formed from a heat shrinkable tube.

11. The pressure resistant vibration absorbing hose as set forth in claim 1, wherein a bursting pressure of the pressure resistant vibration absorbing hose under pressure is 1 MPa or more.

12. The pressure resistant vibration absorbing hose as set forth in claim 1, wherein the reinforcing layer is formed by braiding or spirally winding the reinforcing wire member with braid or winding density of 50% or more.
